(19) United States
(12) Patent Application Publication
(10) Pub. No.: US 2024/0186829 A1
(43) Pub. Date: Jun. 6, 2024

(54) ELECTRONIC DEVICE COMPRISING MAGNET

(71) Applicant: SAMSUNG ELECTRONICS CO., LTD., Suwon-si (KR)

(72) Inventors: Yongjun CHOI, Suwon-si (KR); Junhui LEE, Suwon-si (KR); Jongchul HONG, Suwon-si (KR)

(73) Assignee: SAMSUNG ELECTRONICS CO., LTD., Suwon-si (KR)

(21) Appl. No.: 18/440,537

(22) Filed: Feb. 13, 2024

Related U.S. Application Data
(63) Continuation of application No. PCT/KR2022/012131, filed on Aug. 12, 2022.

(30) Foreign Application Priority Data
Aug. 13, 2021 (KR) 10-2021-0107397
Feb. 9, 2022 (KR) 10-2022-0016752

(51) Int. Cl. H02J 50/12; H01F 7/02; H02J 50/00; H02J 50/70

(52) U.S. Cl. CPC H02J 50/12; H01F 7/021; H01F 7/0221; H02J 50/005; H02J 50/70

(57) ABSTRACT

Provided is an electronic device including a housing including a first surface facing in a first direction, a second surface facing in a second direction opposite to the first direction, and a side surface between the first surface and the second surface; a transmission coil unit disposed adjacent to the first surface and including a coil wound at least once in a clockwise direction or a counterclockwise direction perpendicular to the first direction and the second direction and configured to wirelessly transmit power; a first magnet disposed in a center area inside the housing surrounded by the transmission coil unit; and a second magnet including a first end portion oriented toward the first magnet, a second end portion facing the side surface, and at least a portion of the second magnet is overlapping the transmission coil unit in the first direction.

### CROSS-REFERENCE TO RELATED APPLICATION

This application is a bypass continuation of International Application No. PCT/KR2022/012131, filed on Aug. 12, 2022, in the Korean Intellectual Property Receiving Office, which claims priority to Korean Patent Application No. 10-2021-0107397, filed on Aug. 13, 2021, in the Korean Intellectual Property Office and Korean Patent Application No. 10-2022-0016752, filed on Feb. 9, 2022, in the Korean Intellectual Property Office, the disclosures of which are incorporated by reference herein in their entireties.

### BACKGROUND

### 1. Field

Various embodiments of the disclosure relate to an electronic device including a magnet and, more specifically, to a wireless power transmission device that includes a magnet for alignment between devices and is capable of wirelessly transmitting power.

### 2. Description of Related Art

Wireless recharging technology adopts wireless power transmission/reception. For example, it enables an electronic device to be automatically charged by simply placing the electronic device on a recharging pad.

Wireless charging may be implemented in a few different types, including use of electromagnetic induction, resonance, and radio frequency (RF)/microwave radiation.

Wireless charging-based power transmission methods transmit power between a first coil of the transmission end and a second coil of the reception end. The transmission end generates a magnetic field, and a current is induced and resonated according to variations in magnetic field in the reception end, creating energy.

Wireless charging technology adopting electromagnetic induction or magnetic resonance schemes are recently in wide use for smartphones or such electronic devices. A power transmitting unit (PTU) (e.g., a wireless charging pad) and a power receiving unit (PRU) (e.g., a smartphone or a wearable device (e.g., watch)) come in contact or close to each other within a predetermined distance, the battery of the power receiving unit may be charged by electromagnetic induction or electromagnetic resonance between the transmission coil of the power transmitting unit and the reception coil of the power receiving unit.

### SUMMARY

Provided is an electronic device including a housing including a first surface facing in a first direction, a second surface facing in a second direction opposite to the first direction, and a side surface between the first surface and the second surface; a transmission coil unit disposed adjacent to the first surface and comprising a coil wound at least once in a clockwise direction or at least once in a counterclockwise direction, the clockwise and the counterclockwise directions both being perpendicular to the first direction and the second direction, and the transmission coil unit configured to wirelessly transmit power; a first magnet disposed in a center area inside the housing surrounded by the transmission coil unit; and a second magnet including a first end portion oriented toward the first magnet, a second end portion facing the side surface, and at least a portion of the second magnet is overlapping the transmission coil unit in the first direction.

The electronic device may include a shielding member formed to surround at least a portion of the transmission coil unit.

The electronic device may include the shielding member is formed in a “U” shape opened in the first direction.

The electronic device may include the first magnet is configured to form a magnetic field in the first direction, and the second magnet is configured to form a magnetic field in a third direction perpendicular to the first direction.

The electronic device may include the first magnet and the second magnet at least partially overlap each other in the third direction.

The electronic device may include the first magnet is formed as a cylindrical magnet, and the second magnet is formed as a toroidal shaped magnet to surround the first magnet.

The electronic device may include the second magnet includes at least two magnets.

The electronic device may include the second magnet is disposed in a Halbach shape.

The electronic device may include a substrate, wherein the second magnet is disposed in a space between a shielding member and the substrate.

The electronic device may include the first magnet and the second magnet are disposed on the substrate.

The electronic device may include the second end portion of the second magnet extends to a position corresponding to an outer diameter of the transmission coil unit.

The electronic device may include the second magnet has a predetermined width in a third direction perpendicular to the first direction and the second direction, and wherein the width of the second magnet corresponds to a width of the transmission coil unit.

The electronic device may include the first end portion of the second magnet is a predetermined distance spaced apart from the first magnet.

### BRIEF DESCRIPTION OF DRAWINGS

FIG. 1 is a block diagram illustrating an electronic device in a network environment according to various embodiments of the disclosure;

FIG. 2 is a perspective view illustrating a wireless power transmission device and a wireless power reception device according to various embodiments of the disclosure;

FIG. 3 is an exploded perspective view illustrating a wireless power reception device according to various embodiments of the disclosure;

FIG. 4 is a view illustrating a wireless power transmission device according to various embodiments of the disclosure;

FIG. 5 is a view illustrating a state in which a wireless power transmission device and a wireless power reception device are attached according to various embodiments of the disclosure;

FIG. 6 is a view illustrating a direction in which a second magnet forms a magnetic force according to various embodiments of the disclosure;

FIG. 7A is a perspective view illustrating a magnet assembly according to various embodiments of the disclosure;

FIG. 7B is a side view illustrating a magnet assembly according to various embodiments of the disclosure;

FIG. 7C is a rear perspective view illustrating a magnet assembly according to various embodiments of the disclosure;

FIG. 7D is a rear perspective view illustrating a magnet assembly according to various embodiments of the disclosure;

FIG. 8 is a view schematically illustrating an arrangement relationship between a magnet assembly disposed in a wireless power transmission device and a magnet disposed in a wireless power reception device according to various embodiments of the disclosure;

FIG. 9 is a view illustrating an arrangement relationship between a transmission coil unit and a second magnet according to various embodiments of the disclosure;

FIG. 10 is a view illustrating an arrangement relationship between a transmission coil unit and a second magnet according to various embodiments of the disclosure;

FIG. 11 is a view illustrating an arrangement relationship between a transmission coil unit and a second magnet according to various embodiments of the disclosure;

FIG. 12 is a view illustrating an arrangement relationship between a transmission coil unit and a second magnet according to various embodiments of the disclosure;

FIG. 13 is a view illustrating an arrangement relationship between a transmission coil unit and a second magnet according to various embodiments of the disclosure;

FIG. 14 is a view illustrating an arrangement relationship between a transmission coil unit and a second magnet according to various embodiments of the disclosure;

FIG. 15 is a view illustrating an arrangement relationship between a transmission coil unit and a second magnet according to various embodiments of the disclosure; and

FIG. 16 is a view illustrating an arrangement relationship between a transmission coil unit and a second magnet according to various embodiments of the disclosure.

### DETAILED DESCRIPTION

Hereinafter, embodiments of the present disclosure are described with reference to the accompanying drawings.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

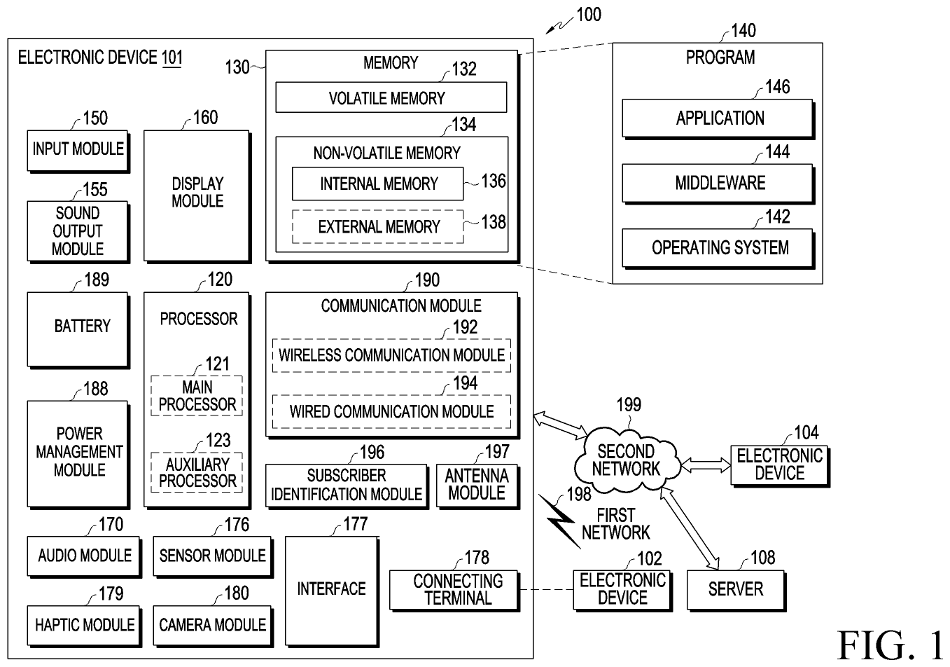

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal According to an embodiment, the display module 160 may include a first display module 351 corresponding to the user's left eye and/or a second display module 353 corresponding to the user's right eye, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for multiple purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductive body or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 may perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

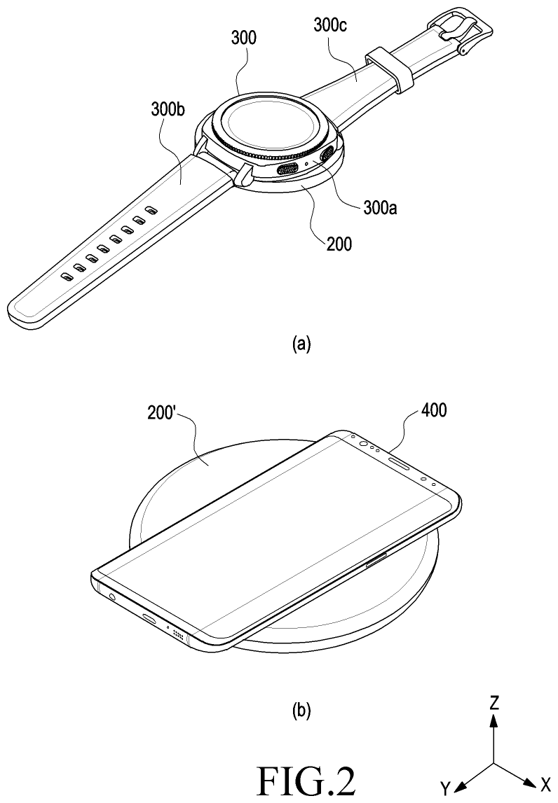

FIG. 2 is a perspective view illustrating a wireless power transmission device and a wireless power reception device according to various embodiments of the disclosure.

Referring to FIG. 2, an electronic device 200 or 200′ (e.g., the electronic device 102 of FIG. 1) may be a wireless power transmission device that wirelessly transmits power. For example, the electronic device 200 or 200′ may be a device that transmits power required by various reception devices that receive wireless power. For example, the electronic device 200 or 200′ may be the wireless charging device that wirelessly transfers power to charge the battery of the wireless power reception device 300 or 400 (e.g., the electronic device 101 of FIG. 1). In describing various embodiments below, the electronic device 200 or 200′ may include at least some of the components illustrated in the electronic device 101 of FIG. 1.

According to various embodiments, the electronic device 200 or 200′ may be implemented as various types of devices that wirelessly transfer power to the wireless power reception device 300 or 400 that requires power. For example, FIG. 2 illustrates a pad-type electronic device 200 or 200′, but is not limited thereto, and may correspond to a mounted electronic device. As another example, the electronic device 200 or 200′ may be a device that selectively provides wireless power to various wireless power reception devices 300 or 400 of different types.

According to various embodiments, the wireless power reception device 300 or 400 may wirelessly receive power from the electronic device 200 to operate. The wireless power reception device 300 or 400 may charge the battery received in the housing using the received wireless power. The wireless power reception device 300 or 400 that wirelessly receives power may include all portable electronic devices, e.g., a mobile phone, a cellular phone, a smart phone, a wearable device (e.g., a watch), an input/output device such as a keyboard, a mouse, an image or voice auxiliary output device, a personal digital assistant (PDA), a portable multimedia player (PMP), a tablet, or a multimedia device.

According to various embodiments, the electronic device 200 or 200′ may wirelessly transmit power to the wireless power reception device 300 or 400 using at least one wireless power transmission method. For example, the electronic device 200 or 200′ may transmit power using one or more of an inductive coupling scheme based on a magnetic induction phenomenon by the wireless power signal and a magnetic resonance coupling scheme based on an electromagnetic resonance phenomenon by the wireless power signal of a frequency.

According to an embodiment, wireless power transmission by the induction coupling scheme may be a technique of wirelessly transmitting power using a primary coil and a secondary coil, and may be a scheme of transmitting power by inducing a current to another coil through a magnetic field that changes in one coil by a magnetic induction phenomenon. As another example, wireless power transmission by the resonance coupling scheme may be a scheme in which resonance occurs in the wireless power reception device 300 or 400 by the wireless power signal transmitted from the electronic device 200 or 200′, and power is transferred from the electronic device 200 or 200′ to the wireless power reception device 300 or 400 by the resonance phenomenon.

One of various embodiments of the wireless power reception device of the disclosure may be a wearable electronic device 300 wearable on the user's body. Referring to FIG. 2(a), a wearable electronic device 300 according to various embodiments may be a smart wrist watch including a main body 300a and wearing members 300b and 300c connected to the main body 300a. Hereinafter, in describing various embodiments of the wearable electronic device 300, a smart watch and the wireless power transmission device 200 therefor are described as examples, but it should be noted that the disclosure is not limited thereto. Further, it should be noted that various embodiments below may be applied to an electronic device in the form of a wireless terminal, such as the smartphone 400 illustrated in FIG. 2(b), and the wireless power transmission device 200′ therefor.

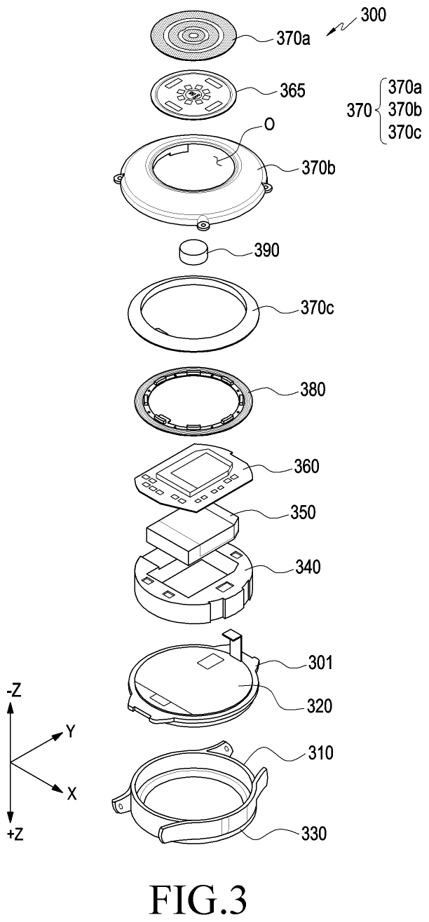

FIG. 3 is an exploded perspective view illustrating an electronic device receiving power according to one of various embodiments.

In the following detailed description, the length direction of the wireless power reception device 300 may be defined as the “Y-axis direction”, the width direction as the “X-axis direction”, and/or the height direction (the thickness direction) as the “Z-axis direction”. In the following detailed description, the mentioned length direction, width direction, and/or height direction may indicate the length direction, the width direction, and/or the height direction of the electronic device. For reference, in FIG. 3, “X” in the orthogonal coordinate system may mean the width direction of the wireless power reception device 300, and “Y” may mean the length direction of the wireless power reception device 300. In an embodiment, “negative/positive (−/+)” may be mentioned together with the Cartesian coordinate system exemplified in the drawings with respect to the direction in which the component is oriented. For example, the first surface (front surface) of the electronic device or the housing may be defined as “a surface facing in the +Z-axis direction (or the first direction)”, and the second surface (rear surface) may be defined as “a surface facing in the −Z-axis direction (or the second direction)”. In describing the direction, when “negative/positive (−/+)” is not described, it may be interpreted as including both the +direction and the −direction unless separately defined. For example, the “Z-axis direction” may be interpreted as including both the +Z direction and the −Z direction. It should be noted that the directions are so defined with respect to the Cartesian coordinate system shown in the drawings for the sake of brevity of description, and the description of these directions or components do not limit various embodiments of the disclosure. Various descriptions of the above-described directions may be applied to the description of the wireless power transmission device 200.

According to an embodiment, the wireless power reception device 300 may include at least one of a display 320, an audio module (e.g., the audio module 170 of FIG. 1), a sensor module (e.g., the sensor module 176 of FIG. 1), a key input device (e.g., the input module 150 of FIG. 1), and a connector hole (e.g., the connecting terminal 178 of FIG. 1). According to an embodiment, the wireless power reception device 300 may exclude at least one (e.g., the key input device, connector hole, or sensor module) of the components or may add other components.

The display 320 may be exposed through a significant portion of the front plate 301. The display 320 may have a shape corresponding to the shape of the front plate 301, e.g., a circle, ellipse, or polygon. The display 320 may be coupled with, or disposed adjacent, a touch detection circuit, a pressure sensor capable of measuring the strength (pressure) of touches, and/or fingerprint sensor.

The wheel key 330 may correspond to a type of key input device. By turning the wheel key 330 clockwise or counterclockwise, the user may select and/or activate various types of applications. According to various embodiments, the wheel key 330 may surround the peripheral portion of the display 320.

The supporting member 340 may be disposed inside the wireless power reception device 300 to be connected with the side bezel structure 310 or integrated with the side bezel structure 310. The supporting member 340 may be formed of, e.g., a metal and/or non-metallic material (e.g., polymer). The supporting member 340 may include a space for disposing or receiving the battery 350. The display 320 may be joined onto one surface of the supporting member 340, and the printed circuit board 360 may be joined onto the opposite surface of the supporting member 274. A processor, memory, and/or interface may be mounted on the printed circuit board 360. The processor may include one or more of, e.g., a central processing unit, an application processor, a graphic processing unit (GPU), a sensor processor, or a communication processor. The memory may include, e.g., a volatile or non-volatile memory. The interface may include, e.g., a high definition multimedia interface (HDMI), a universal serial bus (USB) interface, a secure digital (SD) card interface, and/or an audio interface. The interface may electrically or physically connect, e.g., the wireless power reception device 300 with an external electronic device and may include a USB connector, an SD card/multimedia card (MMC) connector, or an audio connector.

The battery 350 may be a device for supplying power to at least one component of the wireless power reception device 300 and may include, e.g., a rechargeable secondary battery. At least a portion of the battery 350 may be disposed on substantially the same plane as the printed circuit board 360. The battery 350 may be integrally or detachably disposed inside the wireless power reception device 300.

When the side bezel structure 310 or the supporting member 340 includes a metallic material, the first antenna may utilize, e.g., at least a portion of the side bezel structure 310 and/or the supporting member 340 as a radiating conductor. For example, the processor (e.g., the processor 120 of FIG. 1) or the communication module (e.g., the communication module 190 of FIG. 1) may be configured to perform wireless communication using at least a portion of the side bezel structure 310 and/or the supporting member 340. In some embodiments, the first antenna may be disposed between the display 320 and the supporting member 340. The first antenna may include, e.g., a near field communication (NFC) antenna and/or a magnetic secure transmission (MST) antenna. The first antenna may perform short-range communication with, e.g., an external device, or may transmit a short-range communication signal or a magnetic-based signal including payment data. In another embodiment, it may be formed as a combination of an antenna structure disposed between the display 320 and the supporting member 340 and an antenna structure by a portion or combination of the supporting member 340 and/or the side bezel structure 310. In another embodiment, the antenna structure by the side bezel structure 310 and/or the supporting member 340 and the antenna structure disposed between the display 320 and the supporting member 340 may be utilized for wireless communication functions according to different communication protocols.

The auxiliary circuit board 365 may be disposed between the printed circuit board 360 and the rear plate 370 and/or in a space surrounded by the side bezel structure 310. The auxiliary circuit board 365 may be connected with a second antenna, e.g., a near-field communication (NFC) antenna, a wireless charging antenna, and/or a magnetic secure transmission (MST) antenna. In various embodiments of the disclosure, as illustrated in FIG. 3, the second antenna may be implemented as a reception coil unit 380 separated from the auxiliary circuit board 365. In some embodiments, unlike illustrated in the drawings, the second antenna may be mounted on the auxiliary circuit board 365 so that the second antenna and the auxiliary circuit board 365 may be substantially integrally formed with each other. The printed circuit board 360 and/or the auxiliary circuit board 365 may perform short-range communication with an external device, wirelessly transmit/receive power for charging, or transmit magnetic-based signals including payment data or short-range communication signals, using the second antenna. According to another embodiment, an antenna structure may be formed of a portion or combination of the side bezel structure 310 and/or the rear plate 370.

According to various embodiments, the rear plate 370 may include a first cover plate 370a and a second cover plate 370b disposed to surround at least a portion of the first cover plate 370a. In some embodiments, when viewed in the Z-axis direction, the second cover plate 370b may have a loop shape that forms or defines an opening area O, and the first cover plate 370a may be disposed in the opening area O. In the illustrated embodiment, the second cover plate 370b has a substantially circular shape when viewed in the Z-axis direction, but various embodiments of the disclosure are not limited thereto, and the second cover plate 370b may have a polygonal loop shape. In an embodiment, the first cover plate 370a may be coupled to the second cover plate 370b by an adhesive member such as a double-sided tape or a sealing member, and in the opening area O, e.g., a sealing structure or a waterproof structure may be formed between the first cover plate 370a and the second cover plate 370b.

According to various embodiments, the wireless power reception device 300 or the rear plate 370 may further include a molding member 370c disposed on the inner surface of the second cover plate 370b. According to an embodiment, the molding member 370c may be described as a portion of the second cover plate 370b. The molding member 370c may be formed of, e.g., a transparent or translucent synthetic resin, and in an embodiment, the molding member 370c may be disposed to contact the inner surface of the second cover plate 370b while the second cover plate 370b is molded by insert injection molding. In another embodiment, the second cover plate 370b and the molding member 370c may be manufactured in separate processes, and may be coupled to each other through an assembly or attachment process.

According to various embodiments, the reception coil unit 380 may be at least partially disposed on the molding member 370c, and may be configured to generate an induced current in response to an external electromagnetic field. In an embodiment, the reception coil unit 380 may be electrically connected to the printed circuit board 360 or the auxiliary circuit board 365, and the wireless power reception device 300 may use the induced current generated by the reception coil unit 380 as power or may charge the battery 350. In some embodiments, the molding member 370c may be molded in a state in which the reception coil unit 380 is disposed in the molds for molding the molding member 370c. For example, at the same time as the molding member 370c is molded, the reception coil unit 380 may be coupled or fixed to the molding member 370c while being at least partially surrounded by the molding member 370c. In some embodiments, a space in which the reception coil unit 380 is seated may be formed inside the second cover plate 370b, and the first cover plate 370a may be coupled after the reception coil unit 380 is seated on the second cover plate 370b. According to various embodiments, the auxiliary circuit board 365 may be disposed to face the first cover plate 370a. For example, the auxiliary circuit board 365 may be disposed in the opening area O and may be surrounded by the second cover plate 370b or the molding member 370c. In some embodiments, the reception coil unit 380 may be disposed on the rear surface of the second cover plate 370b around the area (e.g., the opening area O) in which the auxiliary circuit board 365 is disposed.

According to various embodiments, a sensor (e.g., the sensor 366 of FIG. 5) may be disposed on the auxiliary circuit board 365. The sensor (e.g., the sensor 366 of FIG. 5) may detect, e.g., user biometric information such as photoplethysmography (PPG), sleep period, skin temperature, heart rate, or electrocardiogram of the user, and the detected biometric information may be stored in the wireless power reception device 300 (e.g., the non-volatile memory 134 of FIG. 1) or may be transmitted to a medical institution in real time to be used for health care of the user. In transmitting the detected biometric information, the processor (e.g., the processor 120 of FIG. 1) and/or the communication module (e.g., the communication module 190 of FIG. 1) may utilize the above-described antenna, e.g., a portion of the side bezel structure 310 or the supporting member 340, the antenna structure disposed between the display 320 and the supporting member 340, and/or the reception coil unit 380, as an antenna.

The sealing member may be configured to block moisture and foreign matter flowing into the space surrounded by the side bezel structure 310 and the rear plate 370 from the outside. The sealing member may be configured to block moisture or foreign bodies that may enter the space surrounded by the side bezel structure 310 and the rear plate 370, from the outside. In some embodiments, the sealing member may include a double-sided tape disposed between the side bezel structure 310 and the front plate 301, and/or an O-ring formed of rubber provided between the side bezel structure 310 and the rear plate 370.

According to various embodiments, the wireless power reception device 300 may include a wireless charging circuit (e.g., a wireless charging circuit provided as a part of the power management module 188 of FIG. 1 and/or the processor 120 of FIG. 1) and a reception coil unit 380. In an embodiment, the reception coil unit 380 may generate an induced current in response to an external electromagnetic field, and the wireless charging circuit may supply power to the wireless power reception device 300 or charge the battery 350 using the induced current generated by the reception coil unit 380.

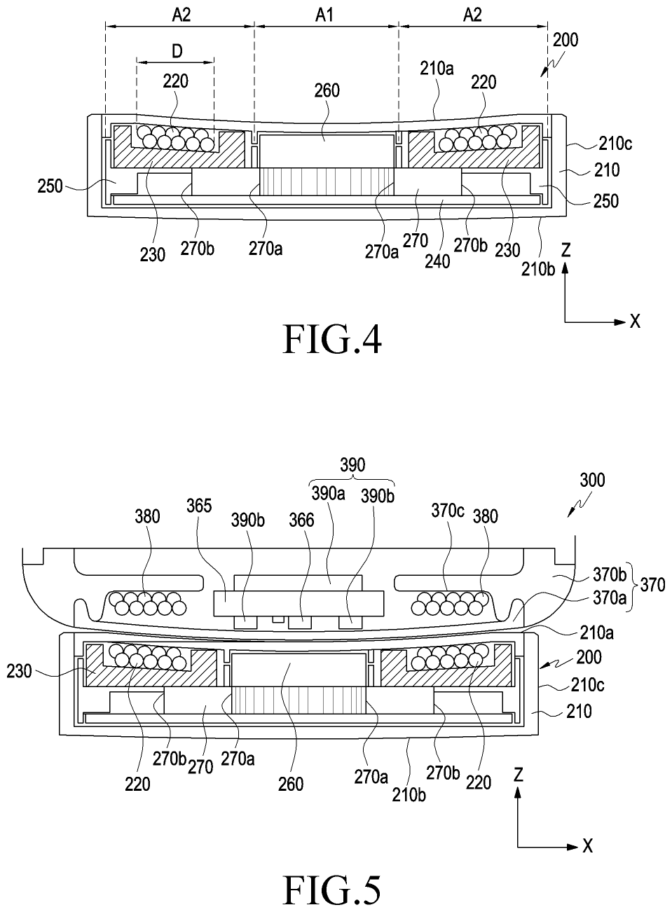

FIG. 4 is a view illustrating a wireless power transmission device according to various embodiments of the disclosure. FIG. 5 is a view illustrating a state in which a wireless power transmission device and a wireless power reception device are attached according to various embodiments of the disclosure.

Referring to FIG. 4, a wireless power transmission device 200 may include a housing 210, a transmission coil unit 220 (e.g., a coil assembly), a shielding member 230, a substrate 240 including a control circuit, a supporting member 250, a first magnet 260, and a second magnet 270. Further, the wireless power transmission device 200 may further include another component (e.g., a fan that discharges the heat generated from the substrate) not shown in the drawings, or omit at least one (e.g., the supporting member 250) of the shown components.

In FIG. 5, a portion of the wireless power reception device 300 together with the wireless power transmission device 200 may be illustrated. The wireless power reception device 300 illustrated in FIG. 5 may include, e.g., a rear plate 370, an auxiliary circuit board 365 disposed adjacent thereto, and a reception coil unit 380, as its components. According to an embodiment, the reception coil unit 380 wound several times or more may be seated on the molding member 370c formed in the second cover plate 370b. In this case, the transmission coil unit 220 may be provided to have a center opening therein, and the auxiliary circuit board 365 may be disposed in an opening formed by the reception coil unit 380.

According to various embodiments, the wireless power transmission device 200 may include a housing 210 including a first surface (or a front surface) 210a facing in a first direction (Z-axis direction), a second surface (or a rear surface) 210b facing in a second direction opposite to the first direction (Z-axis direction), and a side surface 210c surrounding a space between the first surface 210a and the second surface 210b. In another embodiment, the housing 210 may refer to a structure that forms a portion of the first surface 210a, the second surface 210b, and the side surface 210c. According to an embodiment, at least a portion of the first surface 210a, the second surface 210b, and the side surface 210c may be formed of a substantially opaque plate. The plate may be formed of, e.g., coated or colored glass, ceramic, polymer, or a combination of at least two of the materials.

According to various embodiments, the wireless power transmission device 200 may include a coil mounting area A2 in which the transmission coil unit 220 is disposed and a center area A1 positioned inside the coil mounting area A2. The coil mounting area A2 may be disposed along the circumference of the wireless power transmission device 200 to mount the transmission coil unit 220, and the center area A1 may be formed inside the coil mounting area A2 to provide a space for receiving a magnet (the first magnet 260), which is described below. Similar to the wireless power transmission device 200 of FIG. 4, the wireless power reception device 300 may also include a coil mounting area in which the reception coil unit 280 is disposed and a center area A1 positioned inside the coil mounting area. The coil mounting area of the reception coil unit 280 may correspond to the transmission coil unit 220 of the wireless power transmission device 200, and the center area of the reception coil unit 280 may correspond to the center area of the wireless power transmission device 200. The center area of the reception coil unit 280 may be formed inside the coil mounting area and may provide a space for receiving a magnet (the third magnet 390), which is described below.

According to various embodiments, at least one surface of the housing 210 of the wireless power transmission device 200 may include a curve. In other words, at least one of the first surface 210a, the second surface 210b, and/or the side surface 210c may include a curved surface. For example, the first surface 210a may have a shape corresponding to the shape of the housing (e.g., the rear plate 370) of the wireless power reception device 300 capable of wirelessly charging power by the wireless power transmission device 200. As illustrated in FIG. 4, the first surface 210a of the housing 210 may be concavely bent toward the center area A1 to correspond to the shape of the convex lower surface (e.g., the first cover plate 370a) of the wireless power reception device 300. As another example, although not illustrated in the drawings, at least a portion of the housing 210 may further include an area that is bent toward the side surface 210c and extends seamlessly. As another example, the first surface 210a and/or the second surface 210b of the housing 210 may be implemented in any one of a circular shape, an oval shape, and a polygonal shape.

According to various embodiments, the wireless power transmission device 200 may be disposed inside the housing 210 and may include a transmission coil unit 220 for transmitting wireless power. The position of the transmission coil unit 220 may correspond to the position of the reception coil unit 380 of the wireless power reception device 300. According to an embodiment, the transmission coil unit 220 may include a coil wound at least once. When the first surface 210a is viewed from thereabove, the transmission coil unit 220 may be wound several times or more in either clockwise or counterclockwise direction to have a predetermined width D in a third direction perpendicular to the first direction (Z-axis direction) and the second direction. The transmission coil unit 220 may be provided to have an opening in the center thereof, and a conducting line extending from an inner diameter (hereinafter, the inner diameter 220a to be described below with reference to FIG. 10) and/or an outer diameter (hereinafter, an outer 220b to be described below with reference to FIG. 10) may be electrically connected to the substrate 240.

According to various embodiments, the wireless power transmission device 200 may include a shielding member 230 disposed inside the housing 210 and disposed to surround at least a portion of the transmission coil unit 220. According to an embodiment, the shielding member 230 may be formed in a “U” shape, and may be disposed under the transmission coil unit 220 to surround the transmission coil unit 220 in a state in which the opening of the “U” shape faces in the first direction. The shielding member 230 may be disposed between the substrate 240 and the transmission coil unit 220 to shield the magnetic field generated in the transmission coil unit 220 not to face the substrate 240 and/or the electronic components disposed on the substrate 240. As another example, the shielding member 230 may be disposed between the substrate 240 and the transmission coil unit 220 to shield to allow a magnet (the second magnet 270) disposed under the shielding member 230, which is described below, to reduce or prevent an influence on an electromagnetic field formed by the transmission coil unit 220.

According to various embodiments, the shielding member 230 may be provided to have a size corresponding to the area of the transmission coil unit 220. The shielding member 230 may be, e.g., a ferrite or a copper (CU) sheet material, but according to various embodiments, the shielding member 230 may include a cushion material or an embossed material.

According to various embodiments, the wireless power transmission device 200 may include a substrate 240 disposed inside the network environment 100 and disposed to face the transmission coil unit 220 with the shielding member 230 interposed therebetween. A processor, memory, and/or interface may be mounted on the substrate 240. The description of the wireless power reception device 300 with reference to FIG. 3 may apply to a detailed description of the processor, memory, and/or interface.

According to various embodiments, a communication module, a power management module, or the like may be mounted on the substrate 240 of the wireless power transmission device 200 in the form of an integrated circuit chip. As another example, a control circuit may also be configured as an integrated circuit chip and mounted on the substrate 240. For example, the control circuit may be part of the processor or the communication module. As another example, the control circuit may be configured to wirelessly transmit power to the wireless power reception device 300 using the transmission coil unit 220.

According to various embodiments, the wireless power transmission device 200 may include at least one of a sensor module, a key input device, a light emitting device, and a connector hole. The sensor module, the key input device, and the connector hole of the wireless power transmission device 200 may be similar to the sensor module (e.g., the sensor module 176 of FIG. 1) and the connector hole (e.g., the connecting terminal 178 of FIG. 1) of the wireless power reception device 300. According to an embodiment, the electronic device 200 may exclude at least one (e.g., the key input device or the light emitting element) of the components or may add other components. According to an embodiment, the sensor module may sense the wireless power reception device 300 approaching the wireless power transmission device 200, or may generate an electrical signal or a data value corresponding to an internal operating state or an external environment state of the wireless power transmission device 200. The sensor module may include a magnetic field forming check sensor (e.g., a hall sensor) for recognizing the charging state. The light emitting device may be disposed on, e.g., the first surface 210a or the side surface 210c of the housing 210 to provide state information about the wireless power transmission device 200 in the form of light. The connector hole may include a connector hole capable of receiving a connector (e.g., a USB connector) for transmitting and receiving power and/or data to and from an external electronic device.

According to various embodiments, the supporting member 250 of the wireless power transmission device 200 may be formed to support components disposed inside the housing 210. For example, the supporting member 250 may be formed to support the transmission coil unit 220 and the shielding member 230 disposed adjacent to the first surface 210a of the housing 210. According to an embodiment, the supporting member 250 may be formed in the form of a shelf extending from the side surface 210c of the housing 210 to the center area A1 of the housing 210, but is not limited thereto. According to another embodiment, the supporting member 250 may be connected to the substrate 240. According to another embodiment, the supporting member 250 may be formed substantially integrally with the housing 210. The shape of the supporting member 250 may be variously set for each embodiment.

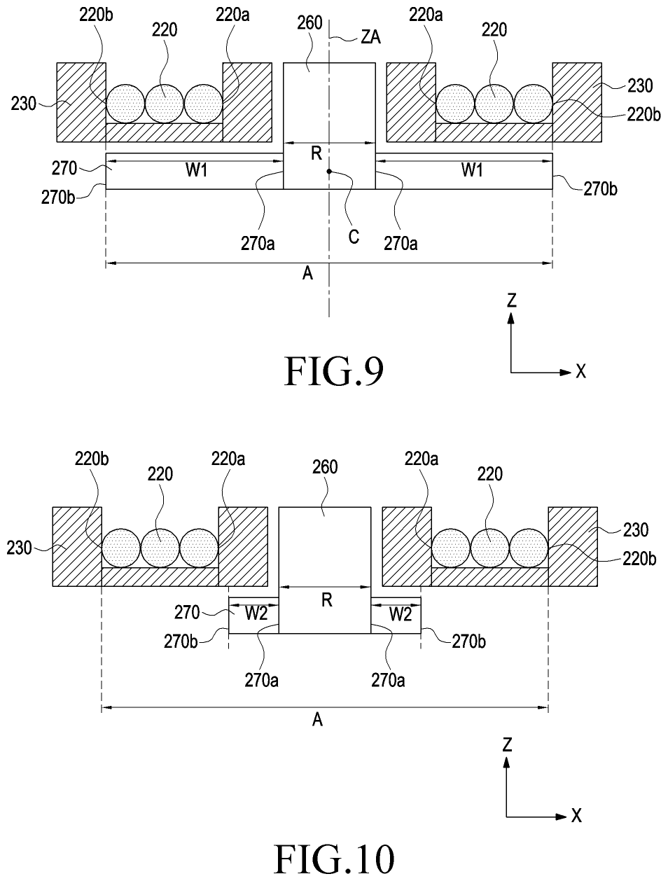

According to various embodiments, a magnet may be disposed inside the housing 210 surrounded by the supporting member 250 of the wireless power transmission device 200. The wireless power transmission device 200 according to various embodiments of the disclosure may include a plurality of magnets. In this case, the plurality of magnets included in the wireless power transmission device 200 may include a first magnet 260 and a second magnet 270. The wireless power transmission device 200 may include the first magnet 260 disposed in the center area A1 inside the housing surrounded by the transmission coil unit 220 and the shielding member 230 and the second magnet 270 having a first end portion oriented toward the first magnet 260, a second end portion facing the side surface 210c of the wireless power transmission device 200, and at least a portion disposed to be stacked with the transmission coil unit 220 in the first direction (Z-axis direction). According to various embodiments, the first magnet 260 may be provided as a cylindrical magnet that is erected in the first direction (Z-axis direction) of the wireless power transmission device 200, and the second magnet 270 may be provided as a toroidal shape magnet that is smaller in height than the first magnet 260 but larger in width than the first magnet 260 to surround the first magnet 260. According to an embodiment, the first magnet 260 may be disposed in the center area A1 inside the housing, and the second magnet 270 may be disposed in a space between the shielding member 230 and the substrate 240. Referring to FIGS. 4 and 5 together, the second magnet 270 may be formed to at least partially overlap the transmission coil unit 220 of the wireless power transmission device 200 in the first direction (Z-axis direction) of the wireless power transmission device 200. Because the reception coil unit 380 of the wireless power reception device 300 is formed at a position corresponding to the transmission coil unit 220 of the wireless power transmission device 200, the second magnet 270 may overlap the reception coil unit 380 of the wireless power reception device 300. For example, the first magnet 260 may be disposed in the center area A1, while the second magnet 270 may be disposed in the coil mounting area A2. According to an embodiment, the wireless power transmission device 200 may be formed in a form in which the second magnet 270, the shielding member 230, and the transmission coil unit 220 are sequentially stacked on the substrate 240. According to an embodiment, the second magnet 270 may at least partially overlap the first magnet 260 in a third direction (X-axis direction) perpendicular to the first direction (height direction). Various embodiments related to the relative positions of the second magnet 270 and the first magnet 260 are described below in detail with reference to the embodiments of FIGS. 9 to 16.

According to various embodiments, a magnet may also be disposed in the wireless power reception device 300. For example, the wireless power reception device 300 may include a third magnet 390. The third magnet 390 is provided to form an attractive force with the first magnet 260 and/or the second magnet 270 of the wireless power transmission device 200 to align the electronic devices 200 and wireless power reception devices 300, and may be disposed on the auxiliary circuit board 365. A sensor 366 for detecting user biometric information may be disposed on the auxiliary circuit board 365, and the third magnet 390 may be provided to provide maximum attaching force (tensile force) in relation to the first magnet 260 without limiting the design of the sensor 366 disposed on the auxiliary circuit board 365. To that end, the third magnet 390 may include a plurality of magnets, and for example, as illustrated in FIG. 5, the third magnet 390 may include at least one of a 3-1th magnet 390a disposed on the upper surface of the auxiliary circuit board 365 and a 3-2th magnet 390b disposed on the lower surface of the auxiliary circuit board 365. In this case, the third magnet 390 disposed on the auxiliary circuit board 365 may not be disposed on the same plane (e.g., XY plane) as the reception coil unit 380 to not affect the power transmission efficiency between the wireless power transmission device and the wireless power reception device.

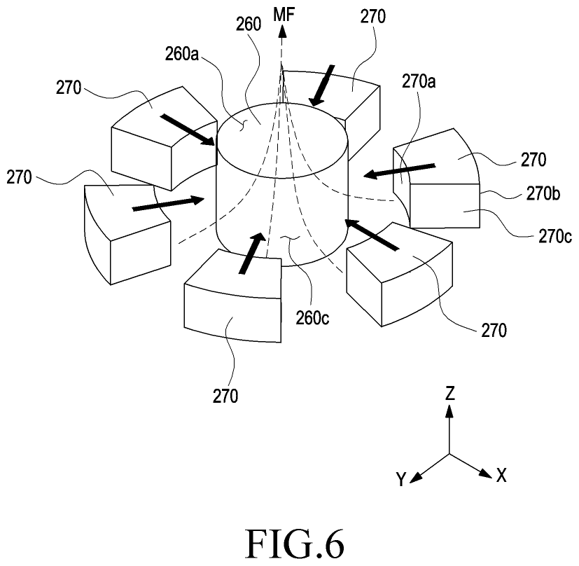

FIG. 6 is a view illustrating a direction in which a second magnet forms a magnetic force according to various embodiments of the disclosure.

By including the second magnet 270, the wireless power transmission device 200 according to various embodiments of the disclosure may provide a greater magnetic force than an embodiment that does not include the second magnet 270, thereby increasing the attaching force between devices.

Further, as the magnetic force provided from the second magnet 270 are added to the magnetic force provided from the first magnet 260, the wireless power transmission device 200 may form a high magnetic field under the wireless charging environment in which the wireless power transmission device 200 is provided. For example, as illustrated in FIG. 6, when the first magnet 260 is oriented in the first direction (Z-axis direction), i.e., when the surface 260a oriented in the first direction (Z-axis direction) forms, e.g., an N-pole, if the second magnet 270 is oriented toward the first magnet 260, the magnetic force of the second magnet 270 may be added to the magnetic force of the first magnet 260, thereby forming a magnet field (MF) having a high attaching force and a high Gaussian value in the first direction (Z-axis direction).

The wireless power transmission device 200 according to various embodiments of the disclosure may have the same effect as providing a magnet assembly having a higher magnetic force without increasing the size of the wireless power transmission device 200 by including the second magnet 270 in the space between the transmission coil unit 220 and the substrate 240.

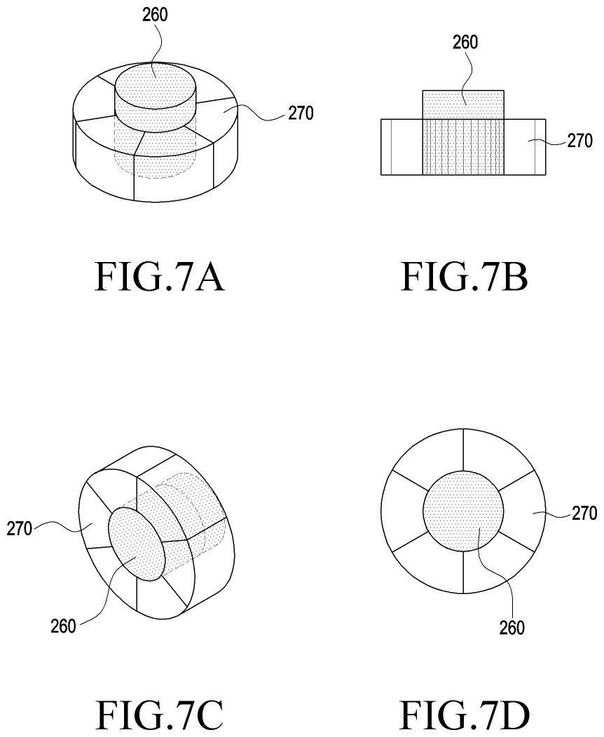

FIG. 7A is a perspective view illustrating a magnet assembly according to various embodiments of the disclosure. FIG. 7B is a side view illustrating a magnet assembly according to various embodiments of the disclosure. FIG. 7C is a rear perspective view illustrating a magnet assembly according to various embodiments of the disclosure. FIG. 7D is a rear perspective view illustrating a magnet assembly according to various embodiments of the disclosure.

Referring further to FIGS. 7A to 7D together with FIG. 6, the second magnet 270 may include two or more magnets. For example, the second magnet 270 may include six sub-magnets, and each of the sub-magnets may be attached adjacent to each other.

Referring to FIG. 6, each of the sub-magnets forming the second magnet 270 may be disposed so that a surface 270a forming one end portion thereof is oriented toward the first magnet 260, and a surface 270b forming the other end portion thereof is oriented toward the side surface 210c of the wireless power transmission device 200. The second magnet 270 including the plurality of sub-magnets may surround the first magnet 260, and the second magnet 270 may form a magnetic field in a third direction perpendicular to the first direction in which the first magnet 260 faces. In this case, the surface 270a forming the one end portion may have a shape corresponding to the side surface 260c of the first magnet 260. For example, when the first magnet 260 is a cylindrical magnet, one end portion of the second magnet 270 may be formed as a curved surface to surround the side surface 260c of the first magnet 260.

Referring to FIGS. 7A to 7D, the magnet assembly including the first magnet 260 and the second magnet 270 according to an embodiment may be formed to contact each other. According to an embodiment, the second magnet 270 may be provided to tightly contact the circumference of the first magnet 260 in a state in which the lower end portion of the second magnet 270 and the lower end portion of the first magnet 260 are connected to each other.

The magnet assembly including the first magnet 260 and the second magnet 270 may be disposed in the inner space including the center area A1 without interfering with other components or structures of the wireless power transmission device 200. When the supporting member 250 is formed inside the housing 210, the magnet assembly is disposed to be fitted into the inner space of the housing 210 except for the supporting member 250 and the shielding member 230, thereby increasing the space utilization of the wireless power transmission device 200 and increasing the attaching force between the devices.

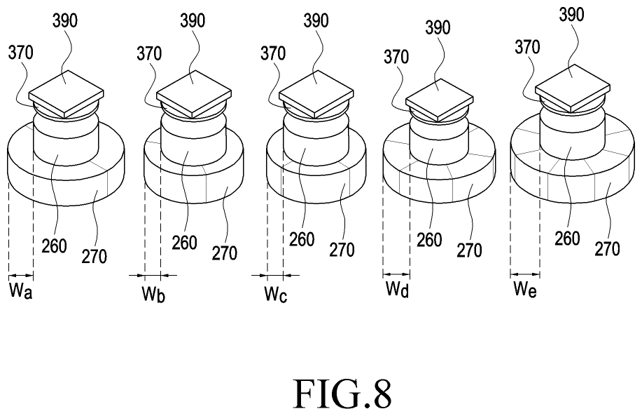

FIG. 8 is a view schematically illustrating an arrangement relationship between a magnet assembly disposed in a wireless power transmission device and a magnet disposed in a wireless power reception device according to various embodiments of the disclosure.

The wireless power reception device 300 may include a third magnet 390. The third magnet 390 may be disposed in an inner area of the mobile housing surrounded by the transmission coil unit, and may be disposed at a position overlapping the first magnet 260 of the wireless power transmission device and not overlapping the second magnet 270 of the wireless power transmission device when the wireless power reception device 300 is aligned with the wireless power transmission device 200 for power charging.

The magnet assembly disposed in the wireless power reception device 300 may be provided with the first magnet 260 and the second magnet 270 in contact with each other, and the third magnet 390 disposed in the wireless power reception device may be disposed at a position spaced apart from the first magnet 260 by a predetermined distance with a portion (e.g., the rear plate 370) of the housing interposed therebetween. The magnet assembly including the first magnet 260 and the second magnet 270 may attach the wireless power transmission device 200 and the wireless power reception device 300 to each other by generating mutual attraction when the magnet assembly is positioned adjacent to the third magnet 390 while forming a larger magnetic field than when only the first magnet 260 is provided.

The magnet assembly may be configured in more various forms. The second magnet included in the magnet assembly may be divided into two or more magnets. For example, the second magnet may be divided into two, or may be divided into three, four, six, eight, or more. The division of the magnet may be set according to the magnetic field specification required when manufacturing the wireless power transmission device 200. Further, the second magnet 270 may have various widths (Wa, Wb, Wc, Wd, or We) between the inner diameter and the outer diameter. For example, the width of the second magnet 270 may be variously set according to the magnetic field specification required when the wireless power transmission device 200 is manufactured.

According to various embodiments, the second magnet 270 may include two or more magnets, and may include at least two magnets having polarity in the third direction (X-axis direction) substantially perpendicular to the first direction (Z-axis direction) and/or the second direction. As an embodiment, the plurality of magnets may be arranged in a Halbach shape. The Halbach arrangement may refer to an arrangement in which a series of permanent magnetic materials form a weak magnetic field in one direction but generate a strong magnetic field in the other direction. According to an embodiment, the second magnet 270 may include a plurality of magnets having a Halbach arrangement having a strong magnetic field toward the first magnet 260.

Hereinafter, an arrangement relationship between the second magnet 270 and the transmission coil unit 220 according to other various embodiments are described with reference to the embodiments of FIGS. 9 to 13.

If the second magnet 270 may further increase the magnetic field of the first magnet 260 while being received in the space inside the wireless power transmission device 200, the second magnet 270 may be formed in the same form as the above-described embodiments as well as in any other form than the above-described embodiments.

FIG. 9 is a view illustrating an arrangement relationship between a transmission coil unit and a second magnet according to various embodiments of the disclosure.

FIG. 9 illustrates a magnet assembly in which a toroidal shape second magnet 270 surrounds the periphery of the first magnet 260, as described with reference to FIGS. 4 to 8. Referring to FIG. 9, for the second magnet 270 according to various embodiments to tightly contact the first magnet 260, a first end portion 270a of the second magnet 270 may face-to-face contact the side surface of the first magnet 260. A second end portion 270b of the second magnet 270 may face the side surface of the electronic device. Further, the center C of the second magnet 270 may be positioned on the central axis ZA of the first magnet 260. For reference, when the central axis ZA of the third magnet 390 of the wireless power reception device 300 is aligned with the central axis of the first magnet 260 and the second magnet 270 in a state in which the wireless power reception device 300 is placed on the wireless power transmission device 200, power transmission efficiency may be maximized.

According to various embodiments, the second magnet 270 may have a predetermined width W1 in the third direction (X-axis direction) perpendicular to the first direction (Z-axis direction) and/or the second direction. The toroidal shape second magnet 270 may have the same width Wi on one side and the other side of the first magnet 260, and may have a substantially rectangular cross section. The width Wi of the second magnet 270 may be variously set (Wa, Wb, Wc, Wd, We in FIG. 5) according to an embodiment as described above with reference to FIG. 8, but may have a large width W1 in the third direction (X-axis direction) as illustrated in FIG. 9 to provide a higher attaching force between devices. According to an embodiment, the width Wi of the second magnet 270 may be greater than the diameter R of the first magnet 260. As illustrated in FIG. 9, even if the second magnet 270 overlaps the transmission coil unit 220, the shielding member 230 is disposed between the second magnet 270 and the transmission coil unit 220, so that the influence of the second magnet 270 on the wireless charging operation of the transmission coil unit 220 is relatively insignificant, and by securing the maximum size of the second magnet 270, the magnitude of the magnetic field (e.g., MF in FIG. 6) may be increased and the attaching force between devices may be significantly increased.

According to various embodiments, in the state in which the first end portion 270a of the second magnet 270 tightly contacts the side surface of the first magnet 260, the second end portion 270b of the second magnet 270 may be extended to a position corresponding to the outer diameter 220b of the transmission coil unit 220. For example, when the distance A from the outer diameter 220b of the transmission coil unit 220 on one side to the outer diameter 220b of the transmission coil unit 220 on the other side is 25.4 mm in a state in which the diameter R of the first magnet 260 is 6 mm, the second magnet 270 of FIG. 9 may have a width W1 of 9.7 mm.

The attaching force and the maximum Gaussian value for each number (2, 4, and 6) of sub-magnets of the second magnet 270 may be measured as shown in Table 1 below. Here, the attaching force gf may refer to the attaching force (or tensile force) between the wireless power transmission device 200 and the wireless power reception device 300, and the maximum Gaussian value G may refer to the Gaussian value measured near the second magnet 270 when the second magnet 270 is disposed in tight contact with the side surface of the first magnet 260 as illustrated in FIG. 9.

TABLE 1

| | | Maximum |
|---|---|---|
| | Attaching | Gaussian |
| Number of | strength | value |
| magnets | (gf) | (G) |
| 2 | 218.9 | 5150 |
| 4 | 258.1 | 5000 |
| 6 | 259.9 | 4940 |

Referring to Table 1, it may be identified that in the embodiment illustrated in FIG. 9, as the number of sub-magnets of the second magnet 270 increases, the maximum Gaussian value slightly decreases, but the attaching force between the wireless power transmission device 200 and the wireless power reception device 300 increases. When the second magnet 270 is disposed in tight contact with the side surface of the first magnet 260, as the number of sub-magnets increases, the attaching force may also increase and, as the number of sub-magnets increases, the Gaussian value G near the second magnet 270 decreases, and thus the influence on wireless charging may decrease. A comparative example may be referenced to review the adequacy of the measured results as shown in Table 1 and the embodiment shown in FIG. 9. FIG. 10 is a view illustrating an arrangement relationship between a transmission coil unit and a second magnet according to a comparative example.

As a comparative example, as illustrated in FIG. 10, when the second magnet 270 is in tight contact with the first magnet 260 having a diameter R of 6 mm, the attaching force and the maximum Gaussian value for each number (2,4,and 6) of sub-magnets of the second magnet 270 may be measured. Here, the attaching force gf may refer to the attaching force (or tensile force) between the wireless power transmission device 200 and the wireless power reception device 300, and the maximum Gaussian value G may refer to the Gaussian value measured near the second magnet 270 when the second magnet 270 is disposed in tight contact with the side surface of the first magnet 260 as illustrated in FIG. 10. In this case, the second magnet 270 according to the embodiment of FIG. 10 may be measured in a state in which the second magnet 270 does not overlap the transmission coil unit 220, e.g., when the width W2 is 3 mm, and the result values in this case may be as shown in Table 2 below.

TABLE 2

| | | Maximum |
|---|---|---|
| | Attaching | Gaussian |
| Number of | strength | value |
| magnets | (gf) | (G) |
| 2 | 183.8 | 3400 |
| 4 | 204.7 | 2960 |
| 6 | 206.5 | 2770 |

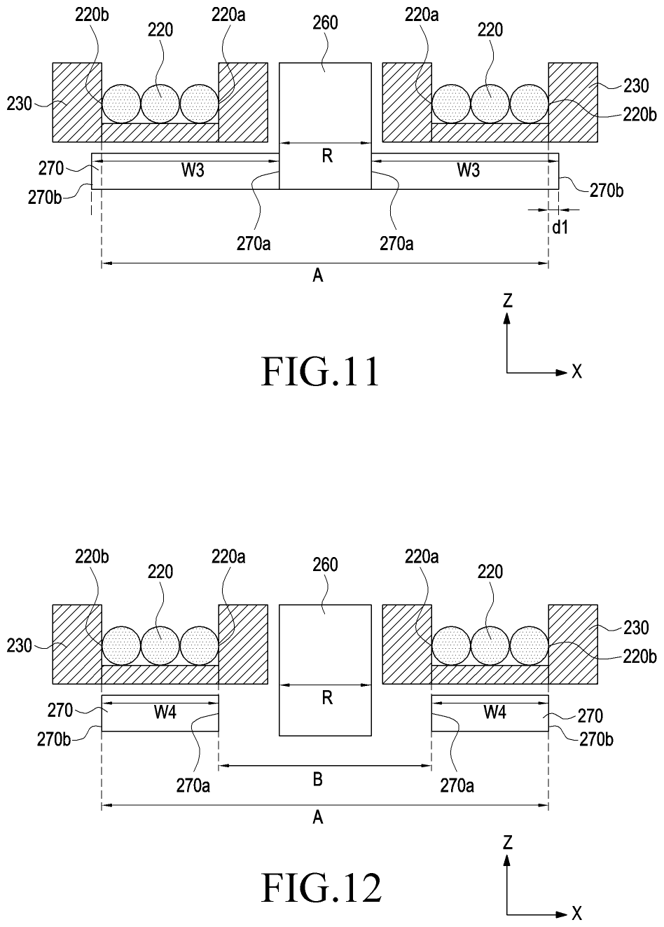

Referring to Table 2, similar to Table 1, it may be identified that as the number of sub-magnets of the second magnet 270 increases, the maximum Gaussian value slightly decreases, but the attaching force between the wireless power transmission device 200 and the wireless power reception device 300 increases. However, referring to Table 2 together with Table 1, it may be identified that in the state in which the second magnet 270 does not overlap the transmission coil unit 220, the attaching force is measured to be significantly smaller than in the state in which the second magnet 270 overlaps the transmission coil unit 220. In an embodiment (e.g., 3 mm) in which the width W2 of the second magnet 270 is formed to be small so that the second magnet 270 does not overlap the transmission coil unit 220, the width W1 of the second magnet 270 may be formed to be large (e.g., 9.7 mm), so that the attaching force may be measured to be significantly smaller than in the state in which the second magnet 270 overlaps the transmission coil unit 220. The Gaussian value G may be greater in the embodiment in which the second magnet 270 overlaps the transmission coil unit 220 (e.g., the width Wi is 9.7 mm) than in the embodiment in which the second magnet 270 does not overlap the transmission coil unit 220 (e.g., the width W2 is 3 mm). However, the influence on wireless charging between devices by the shielding member 230 may not be significant. As the second magnet 270 is disposed around the first magnet 260, the increase in attaching force between devices may outweigh the disadvantage of affecting wireless charging between devices according to an increase in the Gaussian value G. In this case, an electronic device (e.g., the wireless power transmission device 200) according to various embodiments of the disclosure may be provided. In other words, the wireless power transmission device 200 according to various embodiments of the disclosure may include the second magnet 270 extending to an area overlapping the transmission coil unit 220 to have a sufficiently large width. Accordingly, a high attaching force may be secured. FIG. 11 is a view illustrating an arrangement relationship between a transmission coil unit and a second magnet according to various embodiments of the disclosure.

FIG. 11 illustrates a magnet assembly in which a toroidal shape second magnet 270 surrounds the periphery of the first magnet 260, like FIG. 9. However, FIG. 11 may illustrate a form in which first end portion 270a of the second magnet 270 face-to-face contacts a side surface of the first magnet 260, and the second end portion 270b of the second magnet 270 further extends beyond the outer diameter 220b of the transmission coil unit 220 by a predetermined distance d1. For example, when the distance A from the outer diameter 220b of the transmission coil unit 220 on one side to the outer diameter 220b of the transmission coil unit 220 on the other side is 25.4 mm in a state in which the diameter R of the first magnet 260 is 6 mm, the second magnet 270 of FIG. 9 may have a width W3 of 10.1 mm. In this case, the attaching force and the maximum Gaussian value for each number (2, 4, and 6) of sub-magnets of the second magnet 270 may be measured as shown in Table 3 below. Here, the attaching force gf may refer to the attaching force (or tensile force) between the wireless power transmission device 200 and the wireless power reception device 300, and the maximum Gaussian value G may refer to the Gaussian value measured near the second magnet 270 when the second magnet 270 is disposed in tight contact with the side surface of the first magnet 260 as illustrated in FIG. 11.

TABLE 3

| | | Maximum |
|---|---|---|
| | Attaching | Gaussian |
| Number of | strength | value |
| magnets | (gf) | (G) |
| 2 | 219.8 | 4870 |
| 4 | 259.9 | 4870 |
| 6 | 260.8 | 4830 |

Referring to Table 3 together with Table 1, when the second magnet 270 has a width W3 extending further than the outer diameter of the transmission coil unit 220, the attaching force may be measured to be greater or similar to that when the second magnet 270 has a width Wi extending only to the position corresponding to the outer diameter of the transmission coil unit 220. The Gaussian value measured in the vicinity of the second magnet 270 may be measured to be lower when the second magnet 270 has a width W3 extending further than the outer diameter of the transmission coil unit 220 than when the second magnet 270 has a width Wi extending only to the position corresponding to the outer diameter of the transmission coil unit 220, and thus the influence on wireless charging may be slightly smaller. As such, even if the second magnet 270 has a width W3 exceeding the outer diameter 220b of the transmission coil unit 220, the attaching force may not be significantly increased. The state in which the attaching force does not increase significantly may be referred to as a state in which the attaching force limit is reached. In the state in which the attaching force limit is reached as described above, as the width of the second magnet 270 is increased, only the inner space of the housing is occupied, and thus space utilization may be deteriorated. According to various embodiments of the disclosure, the wireless power transmission device 200 may include the second magnet 270 having the second end portion 270b corresponding to the outer diameter 220b of the transmission coil unit 220 or slightly further extending from outer diameter 220b of the transmission coil unit 220 within a previously allowed range in a state in which the first end portion 270a of the second magnet 270 is in tight contact with the side surface of the first magnet 260.

FIG. 12 is a view illustrating an arrangement relationship between a transmission coil unit and a second magnet according to various embodiments of the disclosure.

Referring to FIG. 12, a toroidal shape magnet is illustrated as the second magnet 270. As illustrated in FIG. 12, the second magnet 270 may be formed to be spaced apart from the first magnet 260 by a predetermined distance rather than being in tight contact with the side surface of the first magnet 260.

In this case, the width W4 of the second magnet 270 may be formed to correspond to the width of the transmission coil unit 220. For example, when the diameter of the first magnet 260 is 6 mm, the distance B from the one side inner diameter 220a to the other side inner diameter 220a of the transmission coil unit 220 is 13.2 mm, and the distance A from the one side outer diameter 220b to the other side outer diameter 220b of the transmission coil unit 220 is 25.4 mm, the width W4 of the second magnet 270 of FIG. 12 may be 6.1 mm to be the same as the width of the transmission coil unit 220. In this case, the attaching force and the maximum Gaussian value for each number (2, 4, and 6) of sub-magnets of the second magnet 270 may be measured as shown in Table 4 below. Here, the attaching force gf may refer to the attaching force (or tensile force) between the wireless power transmission device 200 and the wireless power reception device 300. The maximum Gaussian value G may refer to the Gaussian value measured near the second magnet 270 when the second magnet 270 is disposed to face the first magnet 260 while being spaced apart from the first magnet 260 by a predetermined distance, as illustrated in FIG. 12.

TABLE 4

| | | Maximum |
|---|---|---|
| | Attaching | Gaussian |
| Number of | strength | value |
| magnets | (gf) | (G) |
| 2 | 163.8 | 5030 |
| 4 | 179.8 | 5410 |
| 6 | 178.9 | 5600 |

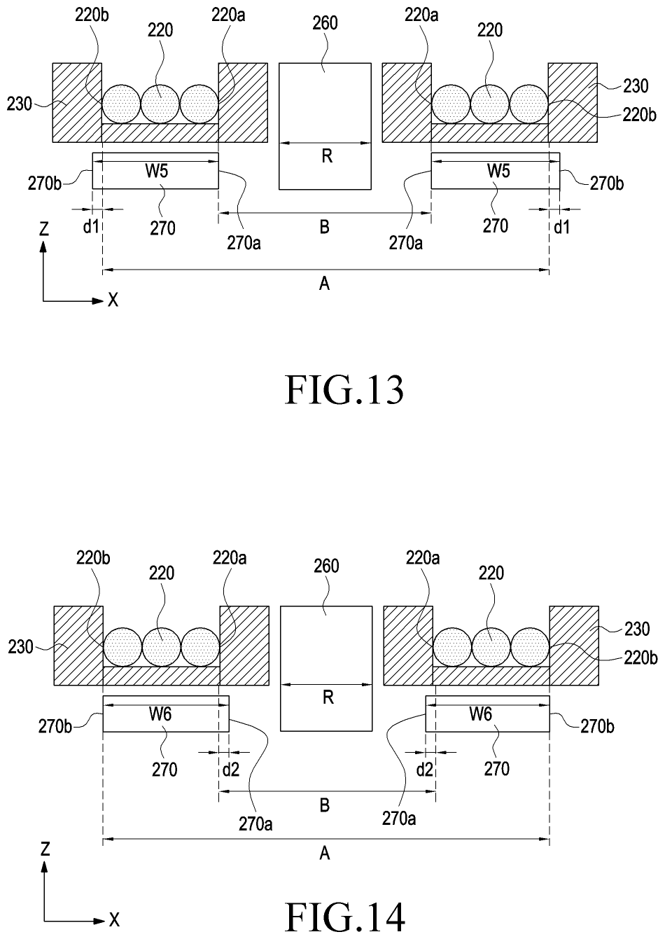

Referring to Table 4, it may be identified that as the number of sub-magnets of the second magnet 270 increases, the maximum Gaussian value of the second magnet 270 and the attaching force between the wireless power transmission device 200 and the wireless power reception device 300 increase. Referring to Table 4 together with Table 1, when the second magnet 270 is formed to be in tight contact with the first magnet 260 as illustrated in FIGS. 6 to 7D, a relatively higher attaching force between devices may be obtained than when the second magnet 270 is not in tight contact with the first magnet 260 as shown in FIG. 12. FIG. 13 is a view illustrating an arrangement relationship between a transmission coil unit and a second magnet according to various embodiments of the disclosure.

Referring to FIG. 13, in a state in which the first end portion 270a of the second magnet 270 is not in tight contact with the side surface of the first magnet 260 but is spaced apart from the first magnet 260 by a predetermined distance, the second end portion 270b of the second magnet 270 may be slightly further extended (e.g., extended by d1) than the outer diameter 220b of the transmission coil unit 220 within a pre-allowed range.

For example, when the diameter of the first magnet 260 is 6 mm, the distance B from one side inner diameter 220a of the transmission coil unit 220 to the other side inner diameter 220a is 13.2 mm, and the distance A from the outer diameter 220b of the transmission coil unit 220 to the other side outer diameter 220b is 25.4 mm, the second magnet 270 of FIG. 13 may be formed to have the width W5 of 6.5 mm so that the second end portion 270b of the second magnet 270 slightly further extends than the outer diameter 220b of the transmission coil unit 220 in the direction away from the central axis (e.g., ZA of FIG. 9) of the first magnet 260. In this case, the attaching force and the maximum Gaussian value for each number (2, 5, and 6) of sub-magnets of the second magnet 270 may be measured as shown in Table 5 below. Here, the attaching force gf may refer to the attaching force (or tensile force) between the wireless power transmission device 200 and the wireless power reception device 300. The maximum Gaussian value G may refer to the Gaussian value measured near the second magnet 270 when the second magnet 270 is disposed to face the first magnet 260 while being spaced apart from the first magnet 260 by a predetermined distance, as illustrated in FIG. 13.

TABLE 5

| | | Maximum |
|---|---|---|
| | Attaching | Gaussian |
| Number of | strength | value |
| magnets | (gf) | (G) |
| 2 | 164.7 | 5000 |
| 4 | 178.9 | 5430 |
| 6 | 178.9 | 5620 |

Referring to Table 5, it may be identified that as the number of sub-magnets of the second magnet 270 increases, the maximum Gaussian value of the second magnet 270 and the attaching force between the wireless power transmission device 200 and the wireless power reception device 300 increase. Referring to Table 5 together with Table 4, it may be identified that even when the second magnet 270 has a width W5 extending further than the outer diameter of the transmission coil unit 220, the attaching force and Gaussian value may be measured to be similar to those when the second magnet 270 has a width W4 extending only to the position corresponding to the outer diameter of the transmission coil unit 220. As such, even if the second magnet 270 has a width exceeding the outer diameter 220b of the transmission coil unit 220, the attaching force may not be significantly increased. In the state in which the attaching force limit is reached as described above, as the width of the second magnet 270 is increased, only the inner space of the housing is occupied, and thus space utilization may be deteriorated. Referring to the embodiments of FIGS. 12 and 13, according to various embodiments of the disclosure, the second end portion 270b of the second magnet 270 may correspond to the outer diameter 220b of the transmission coil unit 220 or may be formed to extend slightly further than the outer diameter 220b of the transmission coil unit 220 within a pre-allowed range.

FIG. 14 is a view illustrating an arrangement relationship between a transmission coil unit and a second magnet according to various embodiments of the disclosure.

FIG. 14 illustrates a form in which unlike FIG. 13, in a state in which the first end portion 270a of the second magnet 270 is spaced apart from the first magnet 260, the second magnet 270 has a width slightly larger than the width of the transmission coil unit 220, but extends (e.g., extends by d2) toward the inner diameter 220a of the transmission coil unit 220 instead of extending toward the outer diameter 220b of the transmission coil unit 220.

For example, when the diameter of the first magnet 260 is 6 mm, the distance B from one side inner diameter 220a of the transmission coil unit 220 to the other side inner diameter 220a is 13.2 mm, and the distance A from the outer diameter 220b of the transmission coil unit 220 to the other side outer diameter 220b is 25.4 mm, the second magnet 270 of FIG. 14 may be formed to have the width W6 of 7.4 mm so that the first end portion 270a slightly further extends than the inner diameter 220a of the transmission coil unit 220 in the direction approaching the central axis (e.g., ZA of FIG. 9) of the first magnet 260. In this case, the attaching force and the maximum Gaussian value for each number (2, 6, and 6) of sub-magnets of the second magnet 270 may be measured as shown in Table 6 below. Here, the attaching force gf may refer to the attaching force (or tensile force) between the wireless power transmission device 200 and the wireless power reception device 300. The maximum Gaussian value G may refer to the Gaussian value measured near the second magnet 270 when the second magnet 270 is disposed to face the first magnet 260 while being spaced apart from the first magnet 260 by a predetermined distance, as illustrated in FIG. 14.

TABLE 6

| | | Maximum |
|---|---|---|
| | Attaching | Gaussian |
| Number of | strength | value |
| magnets | (gf) | (G) |
| 2 | 183.3 | 5100 |
| 4 | 202.9 | 4990 |
| 6 | 205.6 | 4950 |

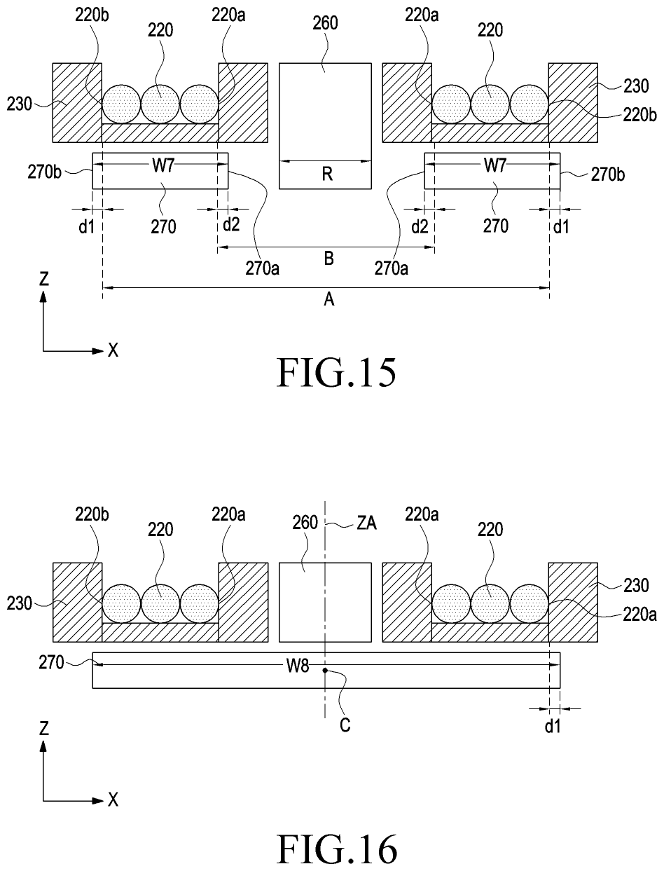

Referring to Table 6 together with Table 4, it may be identified that when the second magnet 270 has a width W6 extending further than the inner diameter of the transmission coil unit 220, the attaching force between devices is noticeably increased as compared with when the second magnet 270 has a width W4 extending only to the position corresponding to the inner diameter of the transmission coil unit 220. However, it may be identified that the magnetic force is measured as lower even though the width is larger. FIG. 15 is a view illustrating an arrangement relationship between a transmission coil unit and a second magnet according to various embodiments of the disclosure. FIG. 15 illustrates a form in which in a state in which the first end portion of the second magnet 270 is spaced apart from the first magnet 260, a width W7 of the second magnet 270 is slightly larger than a width of the transmission coil unit 220, and unlike FIGS. 13 and 14, it extends from the outer diameter 220b and inner diameter 220a of the transmission coil unit 220 to two opposite sides (e.g., extends by d1 and d2, respectively).

For example, when the diameter of the first magnet 260 is 6 mm, the distance B from one side inner diameter 220a of the transmission coil unit 220 to the other side inner diameter 220a is 13.2 mm, and the distance A from the outer diameter 220b of the transmission coil unit 220 to the other side outer diameter 220b is 25.4 mm, the second magnet 270 of FIG. 15 may be formed to have the width W7 of 7.8 mm so that the first end portion 270a and the second end portion 270b, respectively, may slightly further extend than the outer diameter 220b and inner diameter 220a of the transmission coil unit 220. In this case, the attaching force and the maximum Gaussian value for each number (2, 7, and 6) of sub-magnets of the second magnet 270 may be measured as shown in Table 7 below. Here, the attaching force gf may refer to the attaching force (or tensile force) between the wireless power transmission device 200 and the wireless power reception device 300. The maximum Gaussian value G may mean the Gaussian value of the second magnet 270. The maximum Gaussian value G may refer to the Gaussian value measured near the second magnet 270 when the second magnet 270 is disposed to face the first magnet 260 while being spaced apart from the first magnet 260 by a predetermined distance, as illustrated in FIG. 15.

TABLE 7

| | | Maximum |
|---|---|---|
| | Attaching | Gaussian |
| Number of | strength | value |
| magnets | (gf) | (G) |
| 2 | 182.5 | 4840 |
| 4 | 204.7 | 4840 |
| 6 | 205.6 | 4960 |

In summarizing the embodiments related to Table 1, Table 2, Table 3, Table 4, Table 5, Table 6, and Table 7, the second magnet 270 according to various embodiments of the disclosure may be disposed in various forms according to an embodiment and may be formed to have various widths Wi, W2, W3, W4, W5, W6, and W7 while having a width extending to at least partially overlap the transmission coil unit 220, to increase the attaching force between devices. Further, among the embodiments in which the first end portion 270a is spaced apart from the side surface of the first magnet 260, considering the aspect of forming a high attaching force and/or reduced influence on wireless charging, the embodiments in which it has a width further extending from the inner diameter 220a of the transmission coil unit 220 (e.g., the embodiment of FIG. 14) may be different than the embodiments in which it has a width further extending from the outer diameter 220b of the transmission coil unit 220 (e.g., the embodiment of FIG. 13). As described above, the arrangement position and the width of the second magnet 270 mounted on the wireless power transmission device 200 may be determined in consideration of the characteristics of the magnetic field according to the arrangement of the first magnet 260 and the second magnet 270 and the design specifications. FIG. 16 is a view illustrating an arrangement relationship between a transmission coil unit and a second magnet according to various embodiments of the disclosure.

Referring to FIG. 16, the second magnet 270 disposed to overlap the transmission coil unit 220 may be provided in the form of a disk or a rectangular flat plate rather than a donut shape surrounding the first magnet 260. In this case, at least a portion of the second magnet 270 may be stacked with the first magnet 260 in the first direction (Z-axis direction), and another portion of the second magnet 270 may overlap the transmission coil unit 220.

According to an embodiment, when the second magnet 270 is formed in a disk shape or a rectangular flat plate shape under the transmission coil unit 220 and the first magnet 260 as illustrated in FIG. 16, the center C of the second magnet 270 may be disposed to be aligned with the central axis ZA of the first magnet 260.

In the embodiment illustrated in FIG. 16, the width of the second magnet 270 overlapping the transmission coil unit 220 in the wireless power transmission device 200 may be variously set according to an embodiment. Further, the description of the toroidal shape embodiment made above with reference to FIGS. 9 to 15 may be applied to the embodiment of FIG. 16. For example, even if the second magnet 270 in a disk shape or a rectangular flat plate shape has a size exceeding the outer diameter 220b of the transmission coil unit 220, the magnetic force limit in which the magnetic force is not further increased may be reached. Accordingly, the second magnet 270 may be formed so that its outer circumference corresponds to the outer diameter 220b of the transmission coil unit 220, or to have a diameter W8 formed to be slightly larger than the outer diameter 220b of the transmission coil unit 220.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This execution allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. A plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments of the disclosure, there may be provided an electronic device (e.g., the electronic device 200 of FIG. 4) including a housing (e.g., the housing 210 of FIG. 4) including a first surface (e.g., the first surface 210a of FIG. 4) facing in a first direction (e.g., the Z-axis direction of FIG. 4), a second surface (e.g., the second surface 210b of FIG. 4) facing in a second direction opposite to the first direction, and a side surface (e.g., the side surface 210c of FIG. 4) between the first surface and the second surface, a transmission coil unit (e.g., the transmission coil unit 220 of FIG. 4) disposed adjacent to the first surface and including a coil wound at least once in a clockwise direction or a counterclockwise direction perpendicular to the first direction and the second direction and configured to wirelessly transmit power, a first magnet (e.g., the first magnet 260 of FIG. 4) disposed in a center area inside the housing surrounded by the transmission coil unit, and a second magnet (e.g., the second magnet 270 of FIG. 4) including a first end portion (e.g., the first end portion 270a of FIG. 4) oriented toward the first magnet, a second end portion (e.g., the second end portion 270b of FIG. 4) facing the side surface, and at least a portion overlapping the transmission coil unit in the first direction.

According to various embodiments, the electronic device may further include a shielding member (e.g., the shielding member 230 of FIG. 4) formed to surround at least a portion of the transmission coil unit.

According to various embodiments, the shielding member may be formed in a “U” shape opened in the first direction.

According to various embodiments, the first magnet may form a magnetic field in the first direction, and the second magnet may form a magnetic field in a third direction (e.g., the X-axis direction of FIG. 4) perpendicular to the first direction.

According to various embodiments, the first magnet and the second magnet may least partially overlap each other in the third direction.

According to various embodiments, the first magnet may be formed as a cylindrical magnet, and the second magnet may be formed as a toroidal shaped magnet to surround the first magnet.

According to various embodiments, the second magnet may include two or more magnets.

According to various embodiments, the second magnet including the two or more magnets may be disposed in a Halbach shape.

According to various embodiments, the electronic device may further include a substrate (e.g., the substrate 240 of FIG. 4), and the second magnet may be disposed in a space between the shielding member and the substrate.

According to various embodiments, the first magnet and the second magnet may be disposed on the substrate.

According to various embodiments, the second end portion (e.g., the second end portion 270b of FIG. 6) of the second magnet may extend to a position corresponding to an outer diameter (e.g., the outer diameter 220b of FIG. 9) of the transmission coil unit.

According to various embodiments, the second magnet may have a predetermined width in a third direction perpendicular to the first direction and the second direction, and the width of the second magnet may correspond to a width of the transmission coil unit.

According to various embodiments, the first end portion of the second magnet may be a predetermined distance spaced apart from the first magnet.

According to various embodiments of the disclosure, there may be provided an electronic device (e.g., the electronic device 200 of FIG. 4) including a housing (e.g., the housing 210 of FIG. 4) including a first surface (e.g., the first surface 210a of FIG. 4) facing in a first direction (e.g., the Z-axis direction of FIG. 4), a second surface (e.g., the second surface 210b of FIG. 4) facing in a second direction opposite to the first direction, and a side surface (e.g., the side surface 210c of FIG. 4) between the first surface and the second surface, a transmission coil unit (e.g., the transmission coil unit 220 of FIG. 4) disposed adjacent to the first surface and including a coil wound at least once in a clockwise direction or at least once in a counterclockwise direction, the clockwise and counterclockwise directions both being perpendicular to the first direction and the second direction, and the transmission coil unit configured to wirelessly transmit power, a shielding member (e.g., the shielding member 230 of FIG. 4) formed to surround at least a portion of the transmission coil unit and having a “U” shape open in the first direction, a cylindrical first magnet (e.g., the first magnet 260 of FIG. 4) disposed in a center area inside the housing surrounded by the transmission coil unit and the shielding member to form a magnetic field in the first direction, and a toroidal shape second magnet (e.g., the second magnet 270 of FIG. 4) including a first end portion oriented toward the first magnet, a second end portion facing the side surface to form a magnetic field in a third direction perpendicular to the first direction, and at least a portion disposed to be stacked with the transmission coil unit in the first direction, the second magnet including at least two magnets.

According to various embodiments, the first magnet and the second magnet may least partially overlap each other in the third direction.

According to various embodiments, the second magnet may be configured in a Halbach shape.

According to various embodiments, the electronic device may further include a substrate, and the second magnet may be disposed in a space between the shielding member and the substrate.

According to various embodiments, the second end portion of the second magnet may extend to a position corresponding to an outer diameter of the coil unit.

According to various embodiments, the second magnet may have a predetermined width in a third direction perpendicular to the first direction and the second direction, and the width of the second magnet may correspond to a width of the transmission coil unit.

According to various embodiments, the first end portion of the second magnet may be a predetermined distance spaced apart from the first magnet.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. An electronic device, comprising:
a housing comprising a first surface facing in a first direction, a second surface facing in a second direction opposite to the first direction, and a side surface between the first surface and the second surface;
a transmission coil unit disposed adjacent to the first surface and comprising a coil wound at least once in a clockwise direction or at least once in a counterclockwise direction, the clockwise and the counterclockwise directions both being perpendicular to the first direction and the second direction, and the transmission coil unit configured to wirelessly transmit power;
a first magnet disposed in a center area inside the housing surrounded by the transmission coil unit; and
a second magnet comprising a first end portion oriented toward the first magnet, a second end portion facing the side surface, and at least a portion of the second magnet overlapping the transmission coil unit in the first direction.

2. The electronic device of claim 1, further comprising a shielding member formed to surround at least a portion of the transmission coil unit.

3. The electronic device of claim 2, wherein the shielding member is formed in a “U” shape opened in the first direction.

4. The electronic device of claim 1, wherein the first magnet is configured to form a magnetic field in the first direction, and the second magnet is configured to form a magnetic field in a third direction perpendicular to the first direction.

5. The electronic device of claim 4, wherein the first magnet and the second magnet at least partially overlap each other in the third direction.

6. The electronic device of claim 1, wherein the first magnet is formed as a cylindrical magnet, and the second magnet is formed as a toroidal shaped magnet to surround the first magnet.

7. The electronic device of claim 6, wherein the second magnet comprises at least two magnets.

8. The electronic device of claim 7, wherein the second magnet is disposed in a Halbach shape.

9. The electronic device of claim 1, further comprising a substrate, wherein the second magnet is disposed in a space between a shielding member and the substrate.

10. The electronic device of claim 9, wherein the first magnet and the second magnet are disposed on the substrate.

11. The electronic device of claim 1, wherein the second end portion of the second magnet extends to a position corresponding to an outer diameter of the transmission coil unit.

12. The electronic device of claim 1, wherein the second magnet has a predetermined width in a third direction perpendicular to the first direction and the second direction, and wherein the width of the second magnet corresponds to a width of the transmission coil unit.

13. The electronic device of claim 1, wherein the first end portion of the second magnet is a predetermined distance spaced apart from the first magnet.

14. An electronic device comprising:
a housing including a first surface facing in a first direction, a second surface facing in a second direction opposite to the first direction, and a side surface between the first surface and the second surface,
a transmission coil unit disposed adjacent to the first surface and including a coil wound at least once in a clockwise direction or at least once in a counterclockwise direction, the clockwise and counterclockwise directions both being perpendicular to the first direction and the second direction, and the transmission coil unit configured to wirelessly transmit power,
a shielding member formed to surround at least a portion of the transmission coil unit and having a “U” shape open in the first direction,
a cylindrical first magnet disposed in a center area inside the housing surrounded by the transmission coil unit and the shielding member to form a magnetic field in the first direction, and
a toroidal shape second magnet including a first end portion oriented toward the first magnet, a second end portion facing the side surface to form a magnetic field in a third direction perpendicular to the first direction, and
at least a portion disposed to be stacked with the transmission coil unit in the first direction, the second magnet including at least two magnets.

15. The electronic device of claim 14, wherein the first magnet and the second magnet are least partially overlap each other in the third direction.

16. The electronic device of claim 14, wherein the second magnet is configured in a Halbach shape.

17. The electronic device of claim 14, further including:
a substrate, and
wherein the second magnet is disposed in a space between the shielding member and the substrate.

18. The electronic device of claim 14, wherein the second end portion of the second magnet extend to a position corresponding to an outer diameter of the coil unit.

19. The electronic device of claim 14, wherein the second magnet has a predetermined width in a third direction perpendicular to the first direction and the second direction, and
wherein the width of the second magnet corresponds to a width of the transmission coil unit.

20. The electronic device of claim 14, wherein the first end portion of the second magnet is a predetermined distance spaced apart from the first magnet.
